(19) United States
(12) Patent Application Publication
(10) Pub. No.: US 2004/0100913 A1
(43) Pub. Date: May 27, 2004

(54) Method for providing parameters during a change of access, cellular communications system, user equipment and network element

(76) Inventors: Juha Kalliokulju, Vesilahti (FI); Tuija Hurtta, Espoo (FI); Atte Länsisalmi, Espoo (FI); Raino Lintulampi, Kiviniemi (FI); Heikki Einola, Espoo (FI); Ilpo Karjalainen, Oulu (FI); Janne Parantainen, Helsinki (FI); Shkumbin Hamiti, Espoo (FI)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(21) Appl. No.: 10/473,642

(22) PCT Filed: Mar. 28, 2001
(86) PCT No.: PCT/EP01/03532

(51) Int. Cl. H04L 12/26

(52) U.S. Cl. 370/252

(57) ABSTRACT

The invention relates to methods for providing parameter values required at different locations of a cellular communications system for packet header creation, to cellular communications systems and to their components. In order to enable a supply of continuous values for said parameters after a change of access of a user equipment from one network element to another, it is proposed that the parameter is either continuously stored and/or generated in the user equipment throughout a connection or transmitted from a first network element to the user equipment when the access of the user equipment is changed from the first to a second network element. On the other hand, it is proposed that the user equipment transmits said parameter to a network element to which it changes or that the network element to which the user equipment was connected transmits said parameter to the network element to which the user equipment changes.

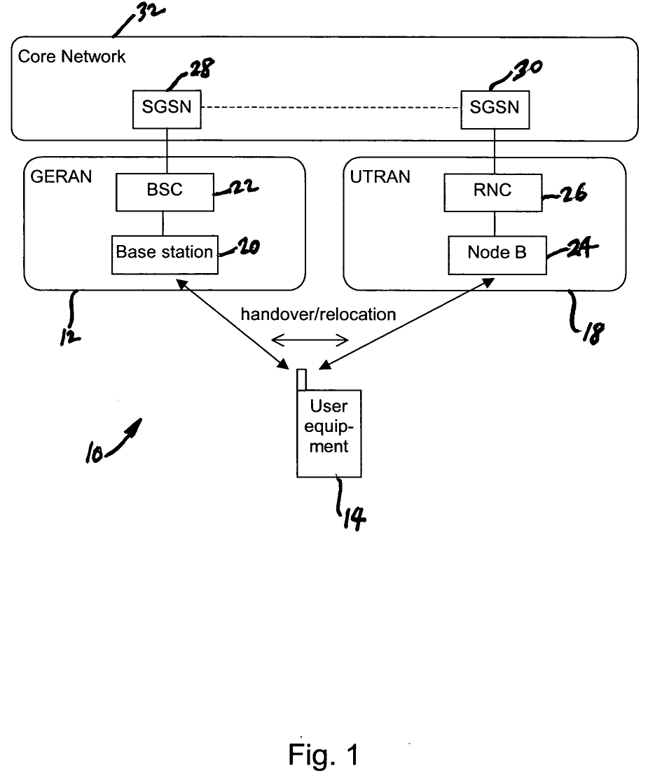

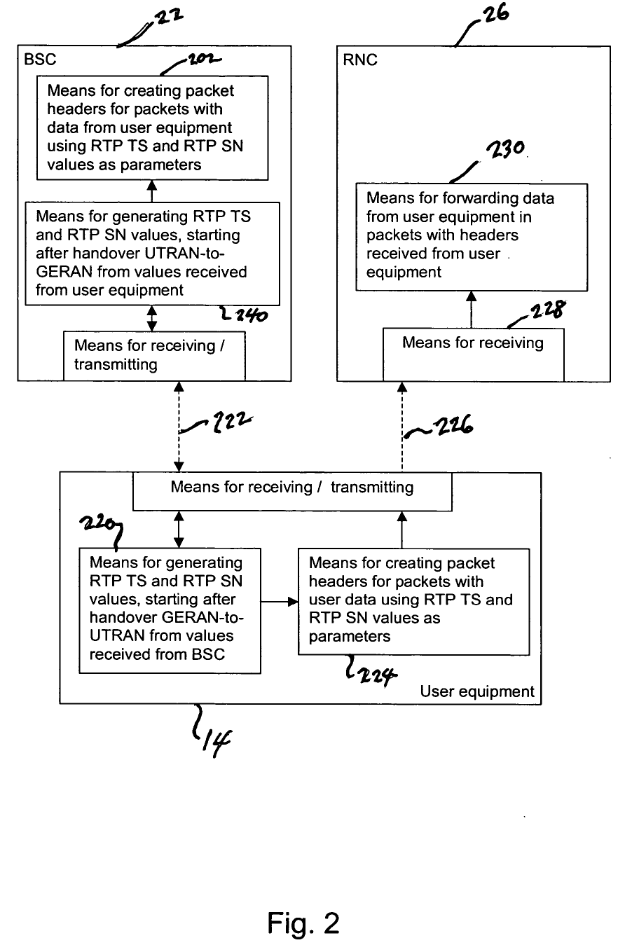

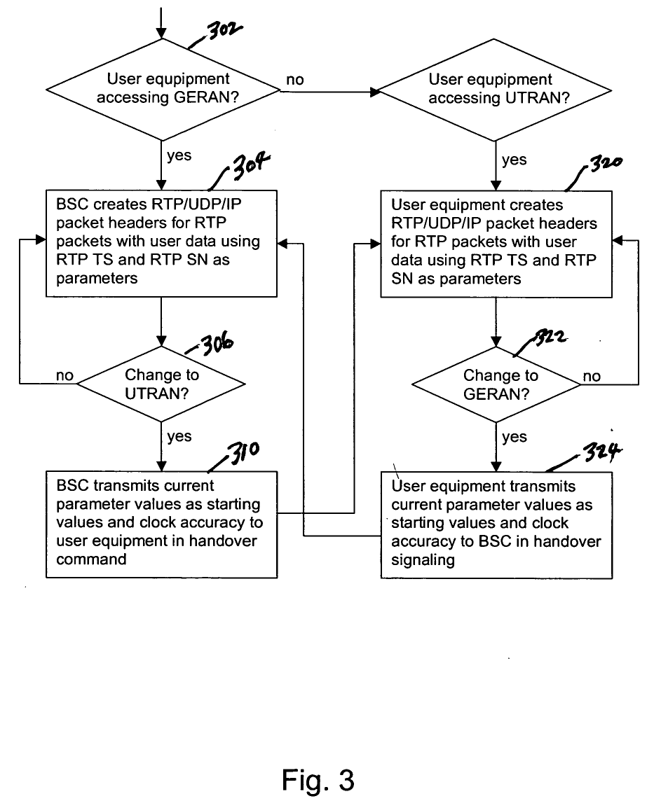

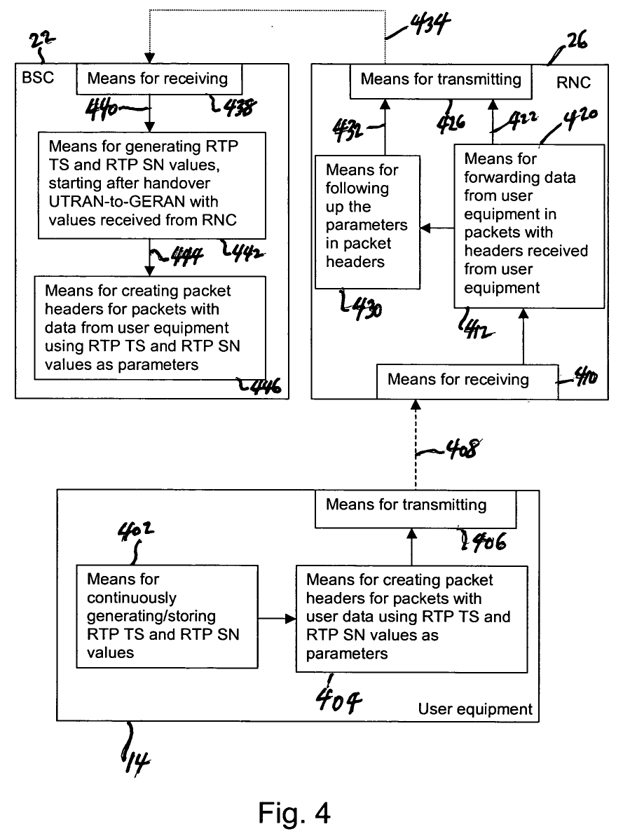

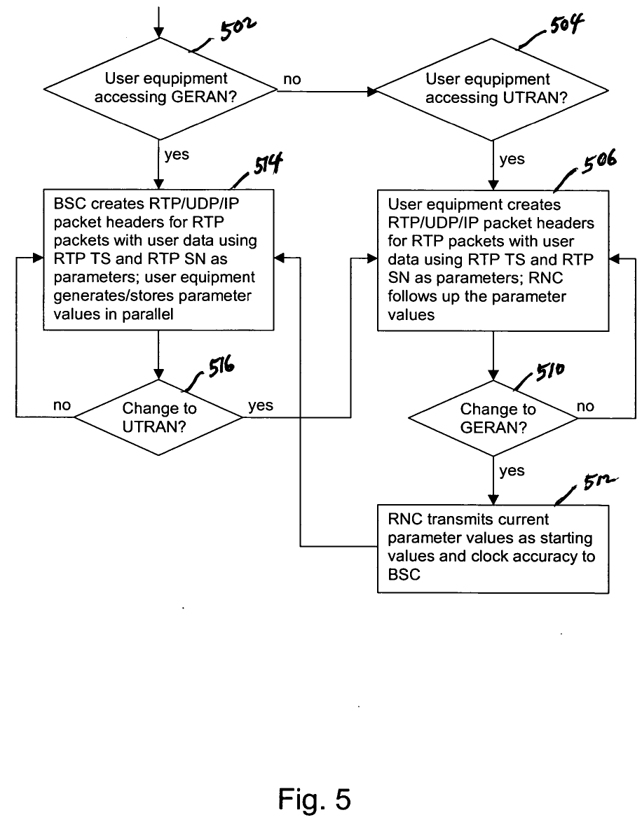

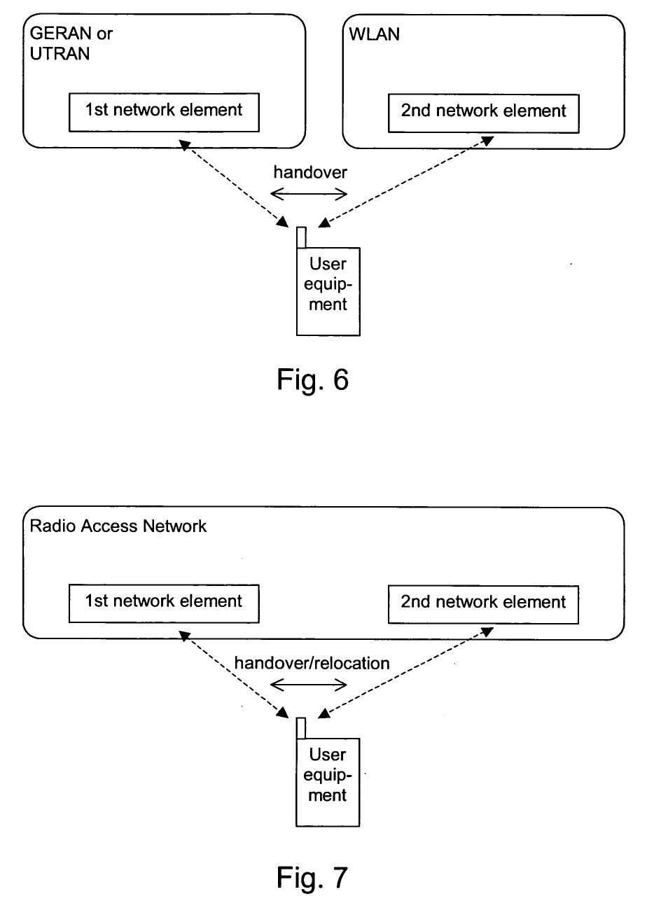

### FIELD OF THE INVENTION

The invention relates to method for providing a user equipment or a network element of a radio access system with a current value of at least one parameter during a change of access of a user equipment from a first network element of a radio access system to a second network element of a radio access system. The invention equally relates to a cellular communications system comprising at least a first network element of a radio access system, a second network element of a radio access system and at least one user equipment suited for accessing either of the at least two network elements and for changing access from one of the network elements to another one of the network elements. The invention further relates to such a user equipment and to such network elements.

### BACKGROUND OF THE INVENTION

In cellular communications systems which transmit user data of a user equipment as payload of packets to a receiving end, packet headers have to be created for each packets and added to the packets in order to enable a correct transmission and processing of the packets and the included data in the cellular communications systems, in a core network and at the receiving end.

The packet headers are created based on different parameters. Parameters that are employed in RTP/UDP/IP (Real Time Protocol/User Datagram Protocol/Internet Protocol) packet header creation are for example real time protocol sequence numbers (SN) and real time timestamps (TS) which are generated for each packet that is to be transmitted and which are needed by the application at the receiving end for processing the data correctly.

The RTP/UDP/IP protocols are described for example in detail in IETF RFC1889 “RTP: A Transport Protocol for Real-Time Applications”, 1996, RFC768 “User Datagram Protocol”, 1980, and RFC760 “DOD Standard Internet Protocol”, 1980. The purpose of the RTP is to provide a function for transferring real time data, e.g. audio and video, over the internet. According to the RTP, header timestamp and sequence number fields give information that can be used in the receiving end to define the right playout time and the right order of the packets. IP and UDP provide mechanisms for transporting frames over the internet to a recipient, i.e. to an IP address port.

Timestamps and sequence numbers are created based on voice frames generated by the codec and on the time elapsed. Basically, for each voice frame the sequence number increases by one. The timestamp increases by a fixed amount of time which depends on the codec for frame length. How much the value of a timestamp increases between subsequent voice frames depends on the time elapsed between the frames.

For the generation of RTP sequence numbers, it has been proposed e.g. in the INTERNET-DRAFT which will receive the RFC number 3095: “RObust Header Compression (ROHC): Framework and four profiles: RTP, UDP, ESP, and uncompressed” by the Network Working Group, Carsten Bormann (ed.), TZI/Uni Bremen, Feb. 26, 2001, to increment the number by one for each packet emitted by an RTP source. For the generation of the RTP timestamps in the audio case it has further been proposed that the timestamp is incremented by a constant delta, corresponding to the number of samples in the speech frame, as long as there are no pauses in the audio stream. The delta does not have to have a 1-to-1 relation to the sequence numbers. It has further been proposed for the generation of the RTP timestamps in the audio case that when there has been a silent period and a new talkspurt begins, the timestamp will jump in proportion to the length of the silent period. Similar proposals exist for the video case.

Thus, it becomes apparent that each generated sequence number and each generated timestamp depends on the respective preceding generated sequence number and timestamp, resulting in a continuity in the sequence of sequence numbers and timestamps.

In a cellular communication system, the location at which the parameters required for packet header creation for a specific user equipment are generated depends on the radio access system of the cellular communications system to which the user equipment is presently connected. The respective location may depend in addition on the configuration of the network element of a single radio access system to which the user equipment is presently connected, if the radio access system comprises network elements with different configurations.

Header removal can be used by some radio access systems or parts of systems because for specific applications the information contained in the RTP/UDP/IP fields is not needed as long as delay jitter is smoothed out on the network side and as long as there is no delay variation in the radio link. In the downlink direction it is possible to define the right playout time already in the network end. Thus, RTP/UDP/IP headers can be removed from voice packets on the network side. In the uplink headers can be created in the network in case the network knows the information that needs to be inserted into different protocol headers. The network can know this information based on an initial signalling, on a local clock, and by tracking the packet numbers.

For example, some systems, like GSM (Global System for Mobile Communications) using GERAN (Global System for Mobile communications Enhanced Data Rates for GSM evolution Radio Access Network) for radio access, support a so called header removal. That means that the necessary packet headers are created in a network element of the radio access system, e.g. a GERAN Base Station Controller (BSC), and also the parameters required for header creation are generated in this network element. In such systems, the user equipment operates only based on the payload part and on what can be communicated within radio channel coding parameters. When header removal is used in downlink direction, protocol headers are removed from the packet on the network side. In the uplink direction headers are generated in the network. This way it is possible on the one hand to avoid protocol overhead over the radio interface and on the other hand to use already existing channel coding schemes which have been optimised for having only voice frame as payload and no upper layer protocol headers.

Other radio access systems, like UMTS (Universal Mobile Telecommunication System) using UTRAN (UMTS Terrestrial Radio Access Network) for radio access, in contrast, do not support header removal. In these systems, the headers are not created in a network element and consequently, the parameters on which the header creation is based are not generated in a network element of the radio access system. Instead, the parameters are generated in the user equipment itself, which user equipment also creates the necessary headers based on the generated parameters. It can be moreover requested by such radio access systems that the created headers be compressed in the user equipment, e.g. by a Robust Header Compression (ROHC). Header compression is used to decrease the protocol overhead. Voice packets typically comprise few tens of bytes and the protocol headers comprise 40-60 bytes. As most of the information in the protocol headers is constant from frame to frame it may be advantageous to compress them for transmission over the radio interface.

An intersystem change of a user equipment between two different radio access systems can take place by handover, if a user equipment supporting both systems changes the radio access technology.

The 3GPP standard TS 23.060 V3.6.0 (2001-01): “Technical Specification; 3rd Generation Partnership Project; Technical Specification Group Services and System Aspects; General Packet Radio Service (GPRS); Service description; Stage 2 (Release 1999)”, describes an intersystem change from UMTS to GSM or from GSM to UMTS for a mobile station supporting both UMTS and GSM. The mobile station has to be GPRS-attached.

The standard mentions in more detail several possible intersystem changes in a system in which GERAN and UTRAN are connected via one or several SGSNs (Serving GPRS Support Node) to network elements of a common core network. More specifically, in GERAN, a base station providing radio access for a user equipment in a specific serving cell is connected via a GERAN BSC to an SGSN and in UTRAN, a node B providing radio access for a user equipment in a specific serving cell is connected via a Radio Network Controller (RNC) to an SGSN, node B(s) and RNC forming part of a Serving Radio Network Subsystem (SRNS).

On the one hand, intra SGSN intersystem changes are described in the standard. Such changes may be enabled by an SGSN that supports both, an interface to UTRAN, in particular an Iu-PS interface, and an interface to GERAN, in particular a Gb or an Iu interface. An intra SGSN intersystem change takes place when a user equipment changes the radio access technology, i.e. from UTRAN to GERAN or vice versa, if the radio access technology nodes serving the user equipment before and after the intersystem change are both served by this SGSN.

On the other hand, inter SGSN intersystem changes are described. An inter SGSN intersystem change from UMTS to GSM takes place when a user equipment changes the radio access technology, i.e. from UTRAN to GERAN or vice versa, if the GSM radio access node and the UTRAN node serving the user equipment are served by different SGSNS.

During the signalling for an intersystem handover, GERAN BSC and UTRAN RNC communicate via an SGSN and the core network with regard to a resource reservation. The respective old access system moreover transmits at some point a handover command to the user equipment.

Such intersystem handovers can result in a problem. The respective unit responsible for generating the parameters needed for header creation in the system to which the user equipment switches is not aware of the current value used in the unit that was responsible for generating the parameters in the system from which the user equipment switches. Therefore the unit now responsible for generating the parameters has to start anew from zero, resulting in a discontinuity in the parameters. Such a discontinuity can cause a disruption in the application at the receiving end.

The same problem can occur also in other changes of access of a user equipment from a first network element to a second network element in case at least one of the network elements supports header removal. This applies also to changes of access between network elements that belong to the same radio access system and/or to changes between network elements which both support header removal.

### SUMMARY OF THE INVENTION

It is an object of the invention to provide methods, cellular communications systems, user equipment, and network elements for radio access systems that enable a supply of continuous values for at least one parameter used in packet header creation after a change of connection of a user equipment from a first to a second network element.

The invention is aimed in particular at two different situations. The first situation is given by a change of access, in particular realised by a handover or SRNS relocation, of a user equipment from a network element that creates packet headers itself to a network element which uses packet headers created in a user equipment. The second situation is given by a change of access, in particular realised by a handover or SRNS relocation, of a user equipment in the opposite direction.

For the first situation, the object is reached according to a first aspect of the invention with a method for providing a user equipment with a current value of at least one parameter during a change of access of said user equipment from a first network element of a radio access system to a second network element of a radio access system. The at least one parameter is required in said first network element for creating packet headers for packets used for transmitting data of said user equipment when the user equipment is connected to said first network element. The at least one parameter is further required in said user equipment for creating packet headers for packets used for transmitting data of said user equipment when the user equipment is connected to said second network element. The current value of said at least one parameter is transmitted by said first network element to said user equipment during signalling for the change of access.

For the first situation, the object is further reached according to the first aspect of the invention with a cellular communications system comprising at least a first network element of a radio access system, a second network element of a radio access system and at least one user equipment suited for accessing either of the at least two network elements and for changing its access from one of the network elements to a respective other one of the network elements. In this cellular communications system, the first network element comprises means for creating based on at least one parameter packet headers for packets used for transmitting data of the user equipment when said user equipment is connected to said first network element and means for transmitting the current value of said at least one parameter to said user equipment during a change of access of said user equipment to said second network element. The user equipment comprises means for creating based on said at least one parameter packet headers for packets used for transmitting data of said user equipment when the user equipment is connected to said second network element. After a change of access from the first network element to the second network element, the user equipment uses the value of said at least one parameter received from the first network element as starting value for said at least one parameter. The second network element, finally, comprises means for transmitting data from a user equipment connected to said second network element in packets with packet headers created in said user equipment.

For the first situation, the object is finally reached according to the first aspect of the invention with a user equipment and a network element for a radio access system corresponding to the user equipment and the network element respectively of the cellular communications system of the first aspect of the invention.

For the first situation, the object is reached according to a second aspect of the invention with a method corresponding to the method of the first aspect of the invention, but wherein instead of transmitting the current value of said at least one parameter by said first network element to the user equipment during signalling for the change of access, the at least one parameter required is stored and/or continuously generated in said user equipment throughout the connection of said user equipment with either one of said network elements.

For the first situation, the object is further reached according to the second aspect of the invention with a cellular communications system comprising at least a first network element of a radio access system, a second network element of a radio access system and at least one user equipment suited for accessing either of the at least two network elements and for changing its access from one of the network elements to a respective other one of the network elements. Again, the first network element comprises means for creating based on at least one parameter packet headers for packets used for transmitting data of said user equipment when said user equipment is connected to said first network element. In contrast to the first aspect, the user equipment comprises means for continuously storing and/or generating a value of said at least one parameter during a connection to either one of said network elements. Like for the first aspect of the invention, the user equipment comprises means for creating based on said at least one parameter packet headers for packets used for transmitting data of said user equipment when the user equipment is connected to said second network element. The second network element comprises means for transmitting data from a user equipment connected to said second network element in packets with packet headers created in said user equipment.

For the first situation, the object is finally reached according to the second aspect of the invention with a user equipment corresponding to the user equipment of the cellular communications system of the second aspect of the invention.

For the second situation, the object is reached according to a third aspect of the invention with a method for providing a first network element of a radio access system with a current value of at least one parameter during a change of access of a user equipment from a second network element of a radio access system to said first network element. Again, the at least one parameter is required in the first network element for creating packet headers for packets used for transmitting data of said user equipment when the user equipment is connected to said first network element. Moreover, the at least one parameter is required again in said user equipment for creating packet headers for packets used for transmitting data of said user equipment when the user equipment is connected to said second network element. Here, the current value of said at least one parameter is transmitted from the user equipment to the first network element signalling for the change of access.

For the second situation, the object is further reached according to the third aspect of the invention with a cellular communications system comprising at least a first network element of a radio access system, a second network element of a radio access system and at least one user equipment suited for accessing either of the at least two network elements and for changing its access from one of the network elements to a respective other one of the network elements. The user equipment comprises means for creating based on at least one parameter packet headers for packets used for transmitting data of said user equipment when the user equipment is connected to said second network element. The user equipment comprises in addition means for transmitting the current value of said at least one parameter to the first network element during a change of access of said user equipment from said second to said first network element. The first network element comprises means for creating based on at least one parameter packet headers for packets used for transmitting data of said user equipment when said user equipment is connected to said first network element. After a change of access of the user equipment from the second network element to the first network element, the first network element uses the value of the at least one parameter received from the user equipment as starting value for the at least one parameter. The second network element comprises again means for transmitting data from a user equipment connected to said second network element in packets with packet headers created in said user equipment.

For the second situation, the object is finally reached according to the third aspect of the invention with a user equipment and a network element for a radio access system corresponding to the user equipment and the network element respectively of the cellular communications system of the third aspect of the invention.

For the second situation, the object is reached according to a fourth aspect of the invention with a method for providing a first network element of a radio access system with a current value of at least one parameter during a change of access of a user equipment from a second network element of a radio access system to said first network element. The at least one parameter is required in said first network element for creating packet headers for packets used for transmitting data of said user equipment when the user equipment is connected to said first network element. The at least one parameter is further required for creating packet headers for packets used for transmitting data of said user equipment when said user equipment is connected to said second network element, wherein the second network element knows the current value of said at least one parameter when said user equipment is connected to said second network element. The current value of said at least one parameter is transferred from the second network element to the first network element during change of access signalling.

For the second situation, the object is further reached according to the fourth aspect of the invention with a cellular communications system comprising at least a first network element of a radio access system, a second network element of a radio access system and at least one user equipment suited for accessing either of the at least two network elements and for changing its access from one of the network elements to a respective other one of the network elements. The second network element comprises means for transmitting data from a user equipment connected to said second network element in packets with packet headers that were created based on the current value of at least one parameter, which value is known in the second network element, and for transmitting said value of said at least one parameter to said first network element. The first network element comprises means for creating based on at least one parameter packet headers for packets used for transmitting data of said user equipment when said user equipment is connected to said first network element. After a change of access of the user equipment from the second network element to the first network element, the first network element uses the value of said at least one parameter received from the second network element as starting value for said at least one parameter.

For the second situation, the object is finally reached according to the fourth aspect of the invention with network elements for radio access systems corresponding to the first and second network element respectively of the cellular communications system of the fourth aspect of the invention.

The invention proceeds from the idea that the value of parameters used before a change of access for creating packet headers should be made available at the location where the parameter is required after the change of access The different aspects of the invention for the different directions of a change of access relate to the different kind of locations in which the required parameters have to be known. In particular, in a network element in which header removal is supported, some parameters have to be known in this network element, whereas the same parameters have to be known in a user equipment in case the user equipment is connected to a network element that does not support header removal.

All aspects of the invention have the advantage that the values used before a change of access are provided at the location where they are needed for header creation after a change of access.

The first situation, to which the first and second aspect of the invention relate, is given in particular by a change of access from a first network element which is part of a GSM radio access system using GERAN for radio access to a second network element which is part of a UMTS radio access system using UTRAN for radio access. However, these aspects can be applied to all changes of access from a first network element supporting header removal to a second network element not supporting header removal, e.g. a handover within a single radio access system, or from a GSM radio access system, using e.g. GERAN, to a WLAN (Wireless local area network), or from a UMTS radio access system, using e.g. UTRAN, to a WLAN.

For the first situation, the first aspect of the invention is based on transmitting the required parameter values from a first network element supporting header removal to the user equipment during a change of access to a network element which requires header generation in the user equipment. This aspect of the invention has the advantage that no additional complexity is required in the user equipment. Further, it ensures that parameters that have to be updated regularly can be maintained without a risk of a clock drift between user equipment and network element.

With this first aspect of the invention, the value of at least one parameter is preferably transmitted in radio resource control (RRC) signalling exchanged during a handover for a change of access. In particular, it can be added to a message transmitted during a handover. This message can be for example a handover command transmitted for an handover from the first system to the user equipment.

If it is assumed that the handover is an intersystem handover to UTRAN, the handover message contains a Handover To UTRAN Information Element which contains all the information that the user equipment needs to access to UTRAN. The values of the parameters transmitted according to the invention could be added for example in a new information element to this message. For intrasystem handovers for which the relocation of the user equipment is carried out as defined in the mentioned specification, or in one of the standards 3GPP TS 25.413 V3.4.0: “UTRAN Iu Interface RANAP Signalling”, Release 1999, and 3GPP TS 25.423 V3.4.0: “UTRAN Iur Interface: RNSAP Signalling”, Release 1999, the parameter values can be carried as a separate information element in Relocation Commit or Forward SRNS Context messages. For intersystem relocations from GERAN to UTRAN it can be assumed that they are basically the same as intrasystem relocations. Parameters that are transferred over Iu/Iur can be included in Iu/Iur messages. In case the parameters are sent to the user equipment then RRC signalling is used. For the latter case, there are two options: Preferably the information is included in the handover command. Alternatively the information could be sent over the Iu-interface to the target network element and after the handover to the user equipment in an RRC, e.g. Radio Bearer reconfiguration, message.

For the first situation, the second aspect of the invention is based on storing the required parameter values continuously in the user equipment regardless of the kind of network element to which it is presently connected. Therefore, the user equipment is enabled to start creating data packet headers with the correct parameters as soon as its access is changed to a system which requires header generation in the user equipment. This aspect of the invention has the advantage that no extra signalling over the air interface is added during a change of access.

In the second aspect of the invention, the value of the at least one parameter is preferably not only stored in the user equipment, but in addition or alternatively continuously updated by the user equipment throughout the connection of the user equipment with one of said radio access systems. That means, the user equipment generates new values of the required parameter no matter if the user equipment needs the parameter for header creation in its present connection. Therefore, as soon as the access of the user equipment is changed from a network element for which it does not need the parameter itself to a network element for which it does need the parameter for header creation, it can continue header creation with the correct current value of the parameter. The user equipment advantageously uses a counter and a timer for creating required changes in the value of said at least one parameter. The necessity of a continuous update naturally depends on the kind of the concerned parameter. It is also possible to store for one or several parameters a fixed value and to continuously generate values of one or several other parameters in the user equipment.

The second situation, to which the first and second aspect of the invention relate, is given in particular by a change of access from a first network element which is part of a UMTS radio access system using UTRAN for radio access to a second network element which is part of a GSM radio access system using GERAN for radio access. However, these aspects can be applied to all changes of access from a first network element not supporting header removal to a second network element supporting header removal, e.g. a change of access within a single radio access system, or from a WLAN to a GSM radio access system, using e.g. GERAN, or from a WLAN to a UMTS radio access system, using e.g. UTRAN.

For the second situation, the third aspect of the invention is based on transmitting the required parameter values from the user equipment to a network element supporting header removal during a change of access to this network element from a network element not supporting header removal. This aspect of the invention has the advantage that the values are transferred from an entity which produces the values anyway for regular operation.

For the second situation, the fourth aspect of the invention is based on transmitting the required parameter values from a network element that may or may not support header removal to a network element supporting header removal during a change of access of a user equipment from the network element that may or may not support header removal to the network element supporting header removal. Even though the fourth aspect of the invention is aimed in particular at a change of access from a network element that does not support header removal to a network element that supports header removal, this aspect of the invention has therefore the advantage that the same procedure can be employed also within a single system or between different systems comprising only network elements supporting header removal, when the responsible network element to which the user equipment is assigned changes. This can be interesting in particular within a system using GERAN when the BSC to which a user equipment is assigned changes.

In this fourth aspect of the invention it is required that if in the network element to which the user equipment is connected first, the user equipment is responsible for creating the packet headers, the network element keeps track of the parameter values generated in the user equipment, which is usually done anyhow. For example, UTRAN has all the information regarding the RTP/UDP/IP field values available in a header decompressor due to the decompression that has to take place in the network since the values are compressed in the user equipment. Further it is required that this network element has to be able to provide the information to another network element. In case the two network elements belong to two different radio access systems that means, an interface has to be provided between the two radio access systems. Such an interface is given e.g. for UTRAN with the Iu to the core network, which core network can be used in common by UTRAN and GERAN and which core network further can have a corresponding interface to GERAN. One possible alternative could also be an Iur interface between GERAN and GERAN, UTRAN and UTRAN or GERAN and UTRAN.

In the second situation, in an intersystem change of access by handover from UTRAN to GERAN the parameter values can be carried in a SGSN context request to the new SGSN and further to the SRNS in a SRNS context request message, which messages are indicated in the mentioned standard 3GPP TS 23.060. From the new RNC in the SRNS, the information is carried to the user equipment in Radio Bearer setup or Radio Bearer reconfiguration messages. Such messages are defined e.g. in the standard 3GPP TS 25.331 V3.5.0: “RRC Protocol Specification”, Release 1999, and in the standard 3GPP TS 25.303 V 3.6.0: “UE Functions and Interlayer Procedures in Connected Mode”, Release 1999.

In all aspects of the invention, the parameter values that are provided according to the invention without disruption during a change of access are in particular values of parameters needed for creating RTP/UDP/IP headers. The invention is of particular relevance for providing at least one of the parameters real time protocol sequence number and real time protocol timestamp to the right location after a change of access, since these parameters require an update on a packet-by-packet basis. In case there is an interruption in the continuity of these parameters, the application needing the data at the receiving end is disturbed. In order to avoid such disturbances, the knowledge of currently valid parameter values at the right location has to be guaranteed throughout a connection, which can be achieved with the proposals of the invention. The invention can be applied, however, to all parameters that have to be known in the user equipment for header generation. Actually, it can even be applied to the whole header.

The change of access in all aspects of the invention is typically related to or identical with a handover. It may, however, also be separated from the handover, e.g. within UTRAN in SRNS relocation case where the radio handover may be timewise linked or not to the SRNS relocation.

In the first, third and fourth aspects of the invention, an additional parameter indicating the accuracy of the clock of the network element or the user equipment transmitting the parameter required in header creation is advantageously signalled as well. This is of particular importance, if it can not be mandated to be the same in two different entities or if the granularity of clock is not high enough.

Preferred embodiments of the invention become apparent from the subclaims.

### DETAILED DESCRIPTION OF THE INVENTION

In the following, the four aspects of the invention are explained in more detail on the basis of two embodiments of the invention.

Both embodiments of the invention are realised in a cellular communications system comprising GERAN for an access of a user equipment to GSM and UTRAN for an access of a user equipment to UMTS. A user equipment supporting both systems can access the cellular communications system either via a base station and a BSC of GERAN or via a node B and an RNC of UTRAN. Such a user equipment can further change its access during a connection from GERAN to UTRAN and vice versa by a handover. GERAN and UTRAN are both connected via SGSNs to a common core network.

The cellular communications system is designed to transmit user data as payload of created RTP packets. Transmitting the data like audio or video data to the core network and further to the other subscriber requires an assignment of RTP sequence numbers and RTP timestamps to the RTP packets that are to be transmitted. RTP sequence numbers and RTP timestamps are used at the receiving end for processing the received data correctly for the respective application. The respective RTP sequence number and RPT timestamp are included in a packet header created for each packet that is to be transmitted.

First, it is assumed that a user equipment has established a connection to the cellular communications system via a base station of GERAN for exchanging data with some other subscriber.

Since GERAN supports header removal in the user equipment, the RTP sequence numbers and RTP timestamps are created in the BSC of GERAN. The user equipment does not have to be aware of these parameters and operates only based on the payload part and on what can be communicated efficiently using specific optimised channels.

Now, the user equipment is to be handed over to UTRAN without interrupting the connection to the other subscriber. The change of system takes place as described for example in the above cited standard. UTRAN, however, does not support header removal in the user equipment, i.e. the RNC of the UTRAN is not designed to create RTP sequence numbers and RTP timestamps for assigning them to the respective RTP packets. Thus, in UTRAN, the user equipment itself generates these parameters and of creating RTP/UDP/IP headers based on the generated parameters for all packets that are to be transmitted. Additionally, the user equipment may compress the created headers by header compression, if header compression is supported by the UTRAN.

In a first embodiment of the invention, in order to guarantee a clear continuation of the RTP sequence numbers and RTP timestamps during a handover from GERAN to UTRAN, the BSC of GERAN, to which the user equipment is connected via a GERAN base station before the handover, adds to a handover command that is transmitted from the BSC to the user equipment the values of the parameters that were currently used in the BSC for this user equipment. The user equipment therefore does not have to start anew from zero when generating RTP sequence numbers and RTP timestamps in UMTS, but can employ the received values as the initial values for further timestamp and sequence number generation. The parameters generated now in the user equipment are then used for creating RTP/UDP/IP headers in the user equipment for the packets that are to be transmitted via UTRAN. Thus the application running at the receiving end and receiving packets with these headers is able to operate without disruption.

When the user equipment now has to be handed over back from UTRAN to GERAN, the BSC of GERAN, to which the user equipment will be connected after handover, takes over again the responsibility for generating RTP timestamps and RTP sequence numbers and for creating based on these parameters headers for packets with user data that is to be transmitted. In order to enable again a continuous generation of timestamps and sequence numbers, the user equipment transmits during the known handover signalling in addition the values of the parameters that were last generated in the user equipment to the BSC. The GERAN BSC is therefore able to generate the timestamps and sequence numbers after handover in continuation of the values last generated in the user equipment.

A second embodiment of the invention proceeds from the same configuration of a cellular communications system.

In this embodiment, however, the user equipment comprises a counter and a timer in order to enable a clear continuation of the sequence numbers and timestamps during handover.

The counter and the timer of the user equipment are employed for creating the required RTP sequence numbers and RTP timestamps throughout a connection of the user equipment to the cellular communications system, regardless of the system to which the user equipment is presently connected and regardless of handovers. Thus, the user equipment is in possession of the correct sequence numbers and timestamps at any time without added signalling over the radio interface during an intersystem handover. When connected to GERAN, the user equipment simply tracks the values without making use of them, since the respective BSC generates the same values in parallel and creates the RTP/UDP/IP headers based on the internally generated values. When connected to UTRAN, the user equipment uses the continuously updated parameter values for creating the correct RTP/UDP/IP headers. Due to the continuous generation of the parameter values, the user equipment is automatically and immediately in possession of the correct values after a handover from GERAN to UTRAN.

On the other hand, when a user equipment is connected to UTRAN in a cellular communications system of the second embodiment of the invention, the RNC of the node B to which a user equipment is presently assigned constantly follows up the RTP sequence numbers and RTP timestamps generated in the user equipment. When the user equipment is handed over from UTRAN to GERAN, the RNC transfers the current values to the GERAN BSC of the base station to which the user equipment is handed over. The parameter values are transferred from the UTRAN RNC to the GERAN BSC by signalling over the Iu and/or the Iur interface which connects UTRAN to the common core network.

1. Method for providing a user equipment with a current value of at least one parameter during a change of access of said user equipment from a first network element of a radio access system to a second network element of a radio access system, which at least one parameter is required in said first network element for creating packet headers for packets used for transmitting data of said user equipment when the user equipment is connected to said first network element, and which at least one parameter is required in said user equipment for creating packet headers for packets used for transmitting data of said user equipment when the user equipment is connected to said second network element, wherein the current value of said at least one parameter is transmitted by said first network element to said user equipment during signalling for the change of access.

2. Method according to claim 1, wherein the value of the at least one parameter is transmitted in radio resource control (RRC) signalling exchanged during a handover for said change of access.

3. Method according to claim 1 or 2, wherein the value of the at least one parameter is added to a message transmitted for a handover for said change of access.

4. Method according to claim 3, wherein the value of the at least one parameter is added to a handover command transmitted for said handover.

5. Method according to one of the preceding claims, wherein the value of the at least one parameter comprises at least one of the current Sequence Number (SN) and the current Real Time Protocol Timestamp (RTP TS).

6. Method according to one of the preceding claims, wherein the packet header is an RTP/UDP/IP (Real Time Protocol/User Datagram Protocol Internet Protocol) header.

7. Method according to one of the preceding claims, wherein in addition to a value of the parameter required for creating packet headers, a value of a parameter indicating the accuracy of a clock used in the first network element is transmitted from said first network element to the user equipment.

8. Method according to one of the preceding claims, wherein the first network element belongs to a first radio access system and the second network element belongs to a second radio access system, and wherein the change of access is realised by an intersystem handover.

9. Method according to claim 8, wherein said first network element is part of a GSM (Global System for Mobile Communications) radio access system using GERAN (Global System for Mobile communications Enhanced Data Rates for GSM evolution Radio Access Network) for radio access and wherein said second network element is part of a UMTS (Universal Mobile Telecommunication System) radio access system using UTRAN (UMTS Terrestrial Radio Access Network) for radio access.

10. Method according to claim 8, wherein said first network element is part of a GSM (Global System for Mobile Communications) radio access system and wherein said second network element is part of a WLAN (Wireless local area network).

11. Method according to claim 8, wherein said first network element is part of a UTMS (Universal Mobile Telecommunication System) radio access system and wherein said second ne work element is part of a WLAN (Wireless local area network).

12. Method according to one of claims 1 to 7, wherein the first and the second network element belong to the same radio access system, and wherein the change of access is an intrasystem handover or SRNS (Serving Radio Network Subsystem) relocation.

13. Method for providing a user equipment with a current value of at least one parameter during a change of access of said user equipment from a first network element of a radio access system to a second network element of a radio access system, which at least one parameter is required in said first network element for creating packet headers for packets used for transmitting data of said user equipment when the user equipment is connected to said first network element, and which at least one parameter is required in said user equipment for creating packet headers for packets used for transmitting data of said user equipment when the user equipment is connected to said second network element, wherein said at least one parameter required is stored and/or continuously generated in said user equipment throughout the connection of said user equipment with one of said radio access systems.

14. Method according to claim 13, wherein the value of the at least one parameter comprises at least one of the parameters Sequence Number (SN) and Real Time Protocol Timestamp (RTP TS).

15. Method according to one of claims 13 to 14, wherein the packet header is an RTP/UDP/IP (Real Time Protocol/User Datagram Protocol/Internet Protocol) header.

16. Method according to one of claims 13 to 15, wherein the first network element belongs to a first radio access system and the second network element belongs to a second radio access system, and wherein the change of access is realised by an intersystem handover.

17. Method according to claim 16, wherein said first network element is part of a GSM (Global System for Mobile Communications) radio access system using GERAN (Global System for Mobile communications Enhanced Data Rates for GSM evolution Radio Access Network) for radio access and wherein said second network element is part of a UMTS (Universal Mobile Telecommunication System) radio access system using UTRAN (UMTS Terrestrial Radio Access Network) for radio access.

18. Method according to claim 16, wherein said first network element is part of a GSM (Global System for Mobile Communications) radio access system and wherein said second network element is part of a WLAN (Wireless local area network).

19. Method according to claim 16, wherein said first network element is part of a UMTS (Universal Mobile Telecommunication System) radio access system and wherein said second network element is part of a WLAN (Wireless local area network).

20. Method according to one of claims 13 to 15, wherein the first and the second network element belong to the same radio access system, and wherein the change of access is an intrasystem handover or SRNS (Serving Radio Network Subsystem) relocation.

21. Method for providing a first network element of a radio access system with a current value of at least one parameter during a change of access of a user equipment from a second network element of a radio access system to said first network element, which at least one parameter is required in said first network element for creating packet headers/for packets used for transmitting data of said user equipment when the user equipment is connected to said first network element, and which at least one parameter is required in said user equipment for creating packet headers for packets used for transmitting data of said user equipment when the user equipment is connected to said second network element, wherein the current value of said at least one parameter is transmitted from the user equipment to said first network element during signalling for the change of access.

22. Method according to claim 21, wherein the value of the at least one parameter is transmitted in radio resource control (RRC) signalling exchanged during a handover for said change of access.

23. Method according to one of claims 21 to 22, wherein the value of the at least one parameter is added to a message transmitted for a handover for said change of access.

24. Method according to one of claims 21 to 23, wherein the value of the at least one parameter comprises at least one of the parameters Sequence Number (SN) and Real Time Protocol Timestamp (RTP TS).

25. Method according to one of claims 21 to 24, wherein the packet header is an RTP/UDP/IP (Real Time Protocol/User Datagram Protocol/Internet Protocol) header.

26. Method according to one of claims 21 to 25, wherein in addition to a value of the parameter required for creating packet headers, a value of a parameter indicating the accuracy of a clock used in the first network element is transmitted from said first network element to the user equipment.

27. Method according to one of claims 21 to 26, wherein the first network element belongs to a first radio access system and the second network element belongs to a second radio access system, and wherein the change of access is realised by an intersystem handover.

28. Method according to claim 27, wherein said first network element is part of a GSM (Global System for Mobile Communications) radio access system using GERAN (Global System for Mobile communications Enhanced Data Rates for GSM evolution Radio Access Network) for radio access and wherein said second network element is part of a UMTS (Universal Mobile Telecommunication System) radio access system using UTRAN (UMTS Terrestrial Radio Access Network) for radio access.

29. Method according to claim 27, wherein said first network element is part of a GSM (Global System for Mobile Communications) radio access system and wherein said second network element is part of a WLAN (Wireless local area network).

30. Method according to claim 27, wherein said first network element is part of a UMTS (Universal Mobile Telecommunication System) radio access system and wherein said second network element is part of a WLAN (Wireless local area network).

31. Method according to one of claims 21 to 26, wherein the first and the second network element belong to the same radio access system, and wherein the change of access is an intrasystem handover or SRNS (Serving Radio Network Subsystem) relocation.

32. Method for providing a first network element of a radio access system with a current value of at least one parameter during a change of access of a user equipment from a second network element of a radio access system to said first network element, which at least one parameter is required in said first network element for creating packet headers for packets used for transmitting data of said user equipment when the user equipment is connected to said first network element, and which at least one parameter is required for creating packet headers for packets used for transmitting data of said user equipment when said user equipment is connected to said second network element, wherein said second network element knows the current value of said at least one parameter when said user equipment is connected to said second network element, and wherein the current value of said at least one parameter is transferred from said second network element to said first network element during signalling for the change of access.

33. Method according to claim 32, wherein the value of the at least one parameter comprises at least one of the parameters Sequence Number (SN) and Real Time Protocol Timestamp (RTP TS).

34. Method according to one of claims 32 to 33, wherein the packet header is an RTP/UDP/IP (Real Time Protocol/User Datagram Protocol/Internet Protocol) header.

35. Method according to one of claims 32 to 34, wherein in addition to a value of the parameter required for creating packet headers, a value of a parameter indicating the accuracy of a clock used in the first network element is transmitted from said first network element to the user equipment.

36. Method according to one of claims 32 to 35, wherein the first network element belongs to a first radio access system and the second network element belongs to a second radio access system, and wherein the change of access is realised by an intersystem handover.

37. Method according to claim 36, wherein said first network element is part of a GSM (Global System for Mobile Communications) radio access system using GERAN (Global System for Mobile communications Enhanced Data Rates for GSM evolution Radio Access Network) for radio access and wherein said second network element is part of a UMTS (Universal Mobile Telecommunication System) radio access system using UTRAN (UMTS Terrestrial Radio Access Network) for radio access.

38. Method according to claim 36, wherein said first network element is part of a GSM (Global System for Mobile Communications) radio access system and wherein said second network element is part of a WLAN (Wireless local area network).

39. Method according to claim 36, wherein said first network element is part of a UMTS (Universal Mobile Telecommunication System) radio access system and wherein said second network element is part of a WLAN (Wireless local area network).

40. Method according to one of claims 32 to 35, wherein the first and the second network element belong to the same radio access system, and wherein the change of access is an intrasystem handover or SRNS (Serving Radio Network Subsystem) relocation.

41. Cellular communications system comprising at least a first network element of a radio access system, a second network element of a radio access system and at least one user equipment suited for accessing either of the at least two network elements and for changing its access from one of the network elements to a respective other one of the network elements, wherein said first network element comprises means for creating based on at least one parameter packet headers for packets used for transmitting data of said user equipment when said user equipment is connected to said first network element and means for transmitting the current value of said at least one parameter to said user equipment during a change of access of said user equipment to said second network element, wherein said user equipment comprises means for creating based on said at least one parameter packet headers for packets used for transmitting data of said user equipment when the user equipment is connected to said second network element, wherein after a change of access from the first network element to the second network element, the user equipment uses the value of said at least one parameter received from said first network element as starting value for said at least one parameter, and wherein said second network element comprises means for transmitting data from a user equipment connected to said second network element in packets with packet headers created in said user equipment.

42. Cellular communications system comprising at least a first network element of a radio access system, a second network element of a radio access system and at least one user equipment suited for accessing either of the at least two network elements and for changing its access from one of the network elements to a respective other one of the network elements, wherein said first network element comprises means for creating based on at least one parameter packet headers for packets used for transmitting data of said user equipment when said user equipment is connected to said first network element, wherein said user equipment comprises means for continuously storing and/or generating a value of said at least one parameter during a connection to either one of said network elements and means for creating based on said at least one parameter packet headers for packets used for transmitting data of said user equipment when the user equipment is connected to said second network element, and wherein said second network element comprises means for transmitting data from a user equipment connected to said second network element in packets with packet headers created in said user equipment.

43. Cellular communications system comprising at least a first network element of a radio access system, a second network element of a radio access system and at least one user equipment suited for accessing either of the at least two radio network elements and for changing its access from one of the network elements to a respective other one of the network elements, wherein said user equipment comprises means for creating based on at least one parameter packet headers for packets used for transmitting data of said user equipment when the user equipment is connected to said second network element, and means for transmitting the current value of said at least one parameter to said first network element during a change of access of said user equipment from said second to said first network element, wherein said first network element comprises means for creating based on at least one parameter packet headers for packets used for transmitting data of said user equipment when said user equipment is connected to said first network element, wherein after a change of access of the user equipment from the second network element to the first network element said first network element uses the value of said at least one parameter received from said user equipment as starting value for said at least one parameter, and wherein said second network element comprises means for transmitting data from a user equipment connected to said second network element in packets with packet headers created in said user equipment.

44. Cellular communications system comprising at least a first network element of a radio access system, a second network element of a radio access system and at least one user equipment suited for accessing either of the at least two network elements and for changing its access from one of the network elements to a respective other one of the network elements, wherein said second network element comprises means for transmitting data from a user equipment connected to said second network element in packets with packet headers that were created based on the current value of at least one parameter, which value is known in the second network element, and for transmitting said value of said at least one parameter to said first network element, and wherein said first network element comprises means for creating based on at least one parameter packet headers for packets used for transmitting data of said user equipment when said user equipment is connected to said first network element, wherein after a change of access of the user equipment from the second network element to the first network element, said first network element uses the value of said at least one parameter received from said second network element as starting value for said at least one parameter.

45. User equipment designed to be able to access at least two different kinds of network elements of one or more radio access systems and comprising means for creating based on at least one parameter packet headers for packets used for transmitting data of said user equipment when the user equipment is connected to one of said network elements which requires headers to be created in user equipment, and means for receiving a starting value for said at least one parameter during a change of access of said user equipment from a network element which does not require headers to be created in said user equipment to a network element which requires headers to be created in said user equipment.

46. User equipment designed to be able to access at least two different kinds of network elements of one or more radio access systems and comprising means for continuously storing and/or generating a value of at least one parameter during a connection to either one of said network elements and means for creating based on said at least one parameter packet headers for packets used for transmitting data of said user equipment when the user equipment is connected to a network element which requires headers to be created in said user equipment.

47. User equipment according to claim 46, wherein said means for continuously storing and/or generating a value of at least one parameter include a counter and a timer.

48. User equipment designed to be able to access at least two different kinds of network elements of one or more radio access systems and comprising means for creating based on at least one parameter packet headers for packets used for transmitting data of said user equipment when the user equipment is connected to one of said network elements which requires headers to be created in user equipment, and means for transmitting the current value of said at least one parameters to a network element which does not require headers to be created in said user equipment during a change of access from a network element which requires headers to be created in said user equipment to said radio access system which does not require headers to be created in said user equipment.

49. Network element for a radio access system of a cellular communications system, which network element comprises means for creating based on at least one parameter packet headers for packets used for transmitting data of a user equipment connected to said network element, and means for transmitting the current value of said at least one parameters to said user equipment during a change of access of said user equipment to another network element requiring a creation of packet headers for packets used for transmitting data of user equipment.

50. Network element for a radio access system of a cellular communications system, which network element comprises means for creating based on at least one parameter packet headers for packets used for transmitting data of a user equipment connected to said network element, and means for receiving from a user equipment during a change of access of said user equipment to said network element from a another network element a starting value for said at least one parameter.

51. Network element for a radio access system of a cellular communications system, which network element comprises means for generating at least one parameter required for creating data packet headers for packets that are to transmit user data of a user equipment accessing said network element, and means for receiving during a change of access of a user equipment to said network element from another network element a starting value for said at least one parameter from said other network element.

52. Network element for a radio access system of a cellular communications system, which network element comprises means for transmitting data from a user equipment connected to said network element in packets with packet headers which were created based on a value of at least one parameter, and means for transmitting said value of said at least one parameter during a change of access of said user equipment to another network element to said other network element.
